(19) United States
(12) Patent Application Publication
(10) Pub. No.: US 2011/0225629 A1
(43) Pub. Date: Sep. 15, 2011

(54) CAPTCHA (Completely Automated Public Test to Tell Computers and Humans Apart) Management Methods and Systems

(75) Inventor: Helen Pai, Cupertino, CA (US)

(73) Assignee: F2WARE INC., Cupertino, CA (US)

(21) Appl. No.: 13/048,591

(22) Filed: Mar. 15, 2011

(30) Foreign Application Priority Data
Mar. 15, 2010 (TW) 99107420

(51) Int. Cl. G06F 21/20

(52) U.S. Cl. 726/3

(57) ABSTRACT

CAPTCHA (Completely Automated Public Test to tell Computers and Humans Apart) management methods and systems are provided. First, information trusted by a server and a client is determined. The server generates CAPTCHA data, and combines the information trusted by the server and the client with the CAPTCHA data. The server transmits the CAPTCHA data to the client. The client determines whether to perform subsequent operations based on the CAPTCHA data according to the information trusted by the server and the client.

### CROSS REFERENCE TO RELATED APPLICATIONS

This application claims priority of Taiwan Patent Application No. 099107420, filed on Mar. 15, 2010, the entirety of which is incorporated by reference herein.

### BACKGROUND OF THE INVENTION

1. Field of the Invention

The disclosure relates generally to CAPTCHA (Completely Automated Public Test to tell Computers and Humans Apart) management methods and systems, and, more particularly to methods and systems that perform additional management, such as security determination for CAPTCHA data.

2. Description of the Related Art

Recently, electronic devices, such as computer systems and portable devices have become more and more popular. Users can use their electronic devices to perform services and applications via a network.

For some network services, users must register specific services, or confirm related information. During the procedure of registering or confirmation, users must view related information provided by a server providing the services, and perform related inputs based on the information, for registering or confirmation. In order to prevent a large amount of animus and repetitive input behaviors, the CAPTCHA technology can be used to differentiate between computers and humans, thus to recognize whether related inputs are input by users or automatically generated by computers.

For standard CAPTCHA technology, users are requested to input texts or numerals displayed on a skew figure. The objective of skewing the figure is to prevent the texts or numerals displayed on the figure from being automatically recognized by some recognition program, such that the CAPTCHA technology loses its efficacy. For example, the CAPTCHA technology is widely used for the message boards of websites. In order to prevent a large amount of advertisements and garbage messages from being published on the message board by computer programs, CAPTCHA technology can be set up to ask the publisher to input texts or numerals, thus to publish the message. Similarly, trading systems, such as a booking system and a financial system on the network may utilize CAPTCHA technology to prevent system attacks and dubious transactions.

However, CAPTCHA technology may be rendered useless. For example, a specific host can install automatic recognition software to try to crack the CAPTCHA, while another host would concurrently monitor the situation, wherein results would be analyzed so that the automatic recognition software may be appropriately adjusted. That is, users cannot be aware that whether the CAPTCHA is falsified by animus websites or hackers. Consequently, performing additional managements for CAPTCHA to enhance the security of CAPTCHA, have become one of the areas currently needed to be overcome in the field.

### BRIEF SUMMARY OF THE INVENTION

CAPTCHA management methods and systems are provided.

In an embodiment of a CAPTCHA management method, information which is trusted by a server and a client is determined. The server generates CAPTCHA data, and combines the information which is trusted by the server and the client with the CAPTCHA data. The information which is trusted by the server and the client is known by viewing the CAPTCHA data. The server transmits the CAPTCHA data to the client. The client determines whether to perform subsequent operations based on the CAPTCHA data according to the information which is trusted by the server and the client, which is combined with the CAPTCHA data.

In an embodiment of a CAPTCHA management method, a server generates CAPTCHA data according to first data and second data, wherein the first data and the second data are known by viewing the CAPTCHA data. Then, the server transmits the CAPTCHA data to a client via a first transmission medium, and transmits the second data to the client via a second transmission medium, wherein the client inputs the first data for processing according to the CAPTCHA data.

In an embodiment of a CAPTCHA management method, a server generates second data according to an algorithm. Then, the server generates CAPTCHA data according to first data and second data, wherein the first data and the second data are known by viewing the CAPTCHA data. Then, the server transmits the CAPTCHA data to a client, wherein the client has the algorithm, and generates the second data according to the algorithm, and inputs the first data for processing according to the CAPTCHA data.

An embodiment of a CAPTCHA management system includes at least a server. The server generates CAPTCHA data according to first data and second data, wherein the first data and the second data are known by viewing the CAPTCHA data. The server transmits the CAPTCHA data to a client via a first transmission medium, and transmits the second data to the client via a second transmission medium, wherein the client inputs the first data for processing according to the CAPTCHA data.

An embodiment of a CAPTCHA management system includes at least a server. The server generates second data according to an algorithm, and generates CAPTCHA data according to first data and second data, wherein the first data and the second data are known by viewing the CAPTCHA data. The server transmits the CAPTCHA data to a client, wherein the client has the algorithm, and generates the second data according to the algorithm, and inputs the first data for processing according to the CAPTCHA data.

In some embodiments, the client can perform a security determination according to the CAPTCHA data received via the first transmission medium and the second data received via the second transmission medium, or according to the second data generated by the client according to the algorithm. When the security determination is passed, the first data is input for processing.

In some embodiments, the second data can be varied according to an algorithm. When the client transmits a request corresponding to the CAPTCHA data to the server at a specific time point. In response to the request, the server generates the second data according to the specific time point using the algorithm.

In some embodiments, the client can generate third data according to the algorithm, generate the second data according to the third data using the algorithm, and transmit the third data to the server. The server can generate the second data according to the third data using the algorithm.

CAPTCHA management methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a CAPTCHA management system of the invention;

FIG. 2 is a flowchart of an embodiment of a CAPTCHA management method of the invention;

FIG. 3 is a schematic diagram illustrating another embodiment of a CAPTCHA management system of the invention;

FIG. 4 is a schematic diagram illustrating an embodiment of an example of CAPTCHA data;

FIG. 5 is a flowchart of another embodiment of a CAPTCHA management method of the invention;

FIG. 6 is a schematic diagram illustrating another embodiment of a CAPTCHA management system of the invention;

FIG. 7 is a flowchart of another embodiment of a CAPTCHA management method of the invention; and

FIG. 8 is a flowchart of another embodiment of a CAPTCHA management method of the invention.

### DETAILED DESCRIPTION OF THE INVENTION

CAPTCHA management methods and systems are provided.

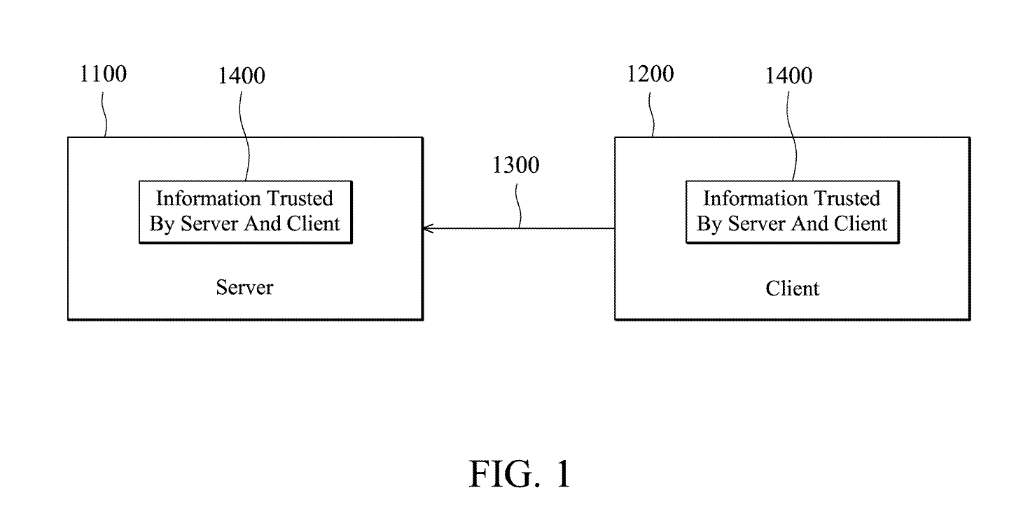

FIG. 1 is a schematic diagram illustrating an embodiment of a CAPTCHA management system of the invention.

The CAPTCHA system comprises a server 1100 and a client 1200. The server 1100 and the client 1200 are coupled via a transmission medium 1300. The server 1100 and/or the client 1200 can have information 1400 which are trusted by the server 1100 and the client 1200. It is understood that, the server 1100 and the client 1200 can use any manner to generate the information 1400 which are trusted by the server 1100 and the client 1200, and the present application is not limited thereto. The server 1100 can generate CAPTCHA data, and combine the information 1400 which are trusted by the server 1100 and the client 1200 with the CAPTCHA data. The server 1100 can transmit the CAPTCHA data to the client 1200 via the transmission medium 1300. The client 1200 can determine whether to perform subsequent operations based on the CAPTCHA data according to the information 1400 which are trusted by the server 1100 and the client 1200, which is combined with the CAPTCHA data. For example, the client 1200 can determine whether to input related data recognized from the CAPTCHA data, and transmit the related data to the server 1100.

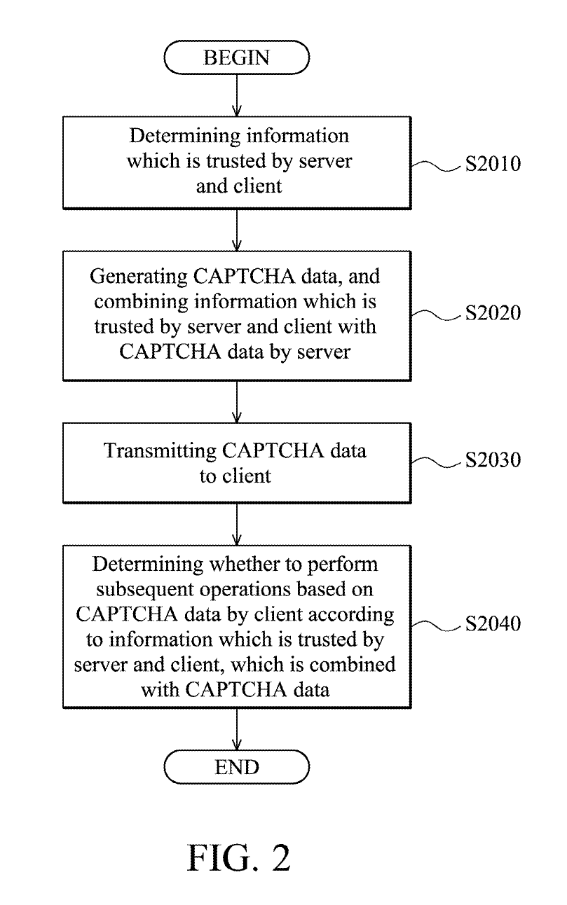

FIG. 2 is a flowchart of an embodiment of a CAPTCHA management method of the invention. The embodiment of FIG. 2 is discussed as follows by referring to FIGS. 1 and 2.

In step S2010, the server 1100 and the client 1200 determine information 1400 which is trusted by the server 1100 and the client 1200. In step S2020, the server 1100 generates CAPTCHA data, and combines the information 1400 which is trusted by the server and the client with the CAPTCHA data. It is noted that, the information 1400 which is trusted by the server and the client is known by viewing the CAPTCHA data. It is understood that, in some embodiments, the CAPTCHA data may be figures, videos or audios. In step 2030, the server 1100 transmits the CAPTCHA data to the client 1200. In step S2040, the client 1200 determines whether to perform subsequent operations based on the CAPTCHA data according to the information 1400 which is trusted by the server and the client, which is combined with the CAPTCHA data. In some embodiments, the client 1200 can view the information 1400 which is trusted by the server and the client from the CAPTCHA data, and determine whether the information 1400 which is trusted by the server and the client viewed from the CAPTCHA data conforms to that stored in the client 1200. If so, subsequent operations are performed based on the CAPTCHA data.

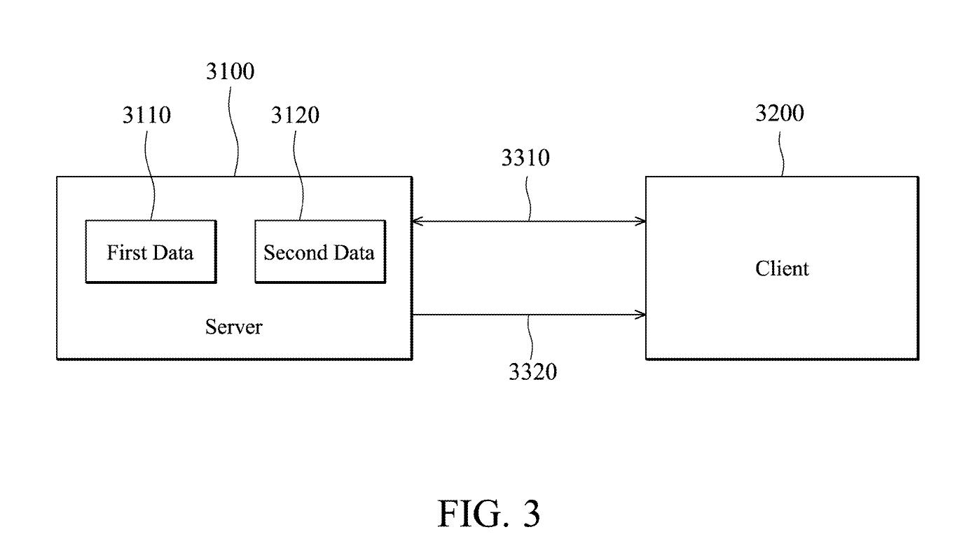

FIG. 3 is a schematic diagram illustrating another embodiment of a CAPTCHA management system of the invention.

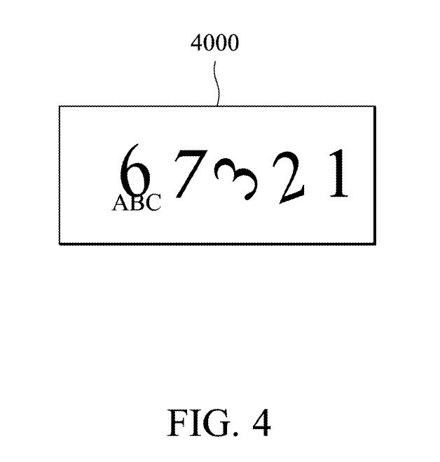

The CAPTCHA system comprises a server 3100 and a client 3200. The server 3100 can have first data 3110 and second data 3120. The first data 3110 and the second data 3120 can be used to generate CAPTCHA data. It is noted that, the first data 3110 and the second data 3120 can be known by viewing the CAPTCHA data. In one example, when the first data is ‘67321’ and the second data is ‘ABC’, the CAPTCHA data 4000 generated according to the first data and the second data can be as shown in FIG. 4. It is noted that, in this example, the CAPTCHA data 4000 is a figure. However, in some embodiments, in addition to being a figure, the CAPTCHA data may also be a video or an audio. In this embodiment, the server 3100 can transmit the CAPTCHA data to the client 3200 via a first transmission medium 3310, and transmit the second data 3120 used to generate the CAPTCHA data to the client 3200 via a second transmission medium 3320. It is understood that, in some embodiments, the first transmission medium 3310 may be the Internet, and the second transmission medium 3320 may be an IP (Internet Protocol) connection, or a telecommunication network. In some embodiments, the second data 3120 can be transmitted to the client 3200 via the second transmission medium 3320 using an email message or a message. The CAPTCHA management method is discussed later.

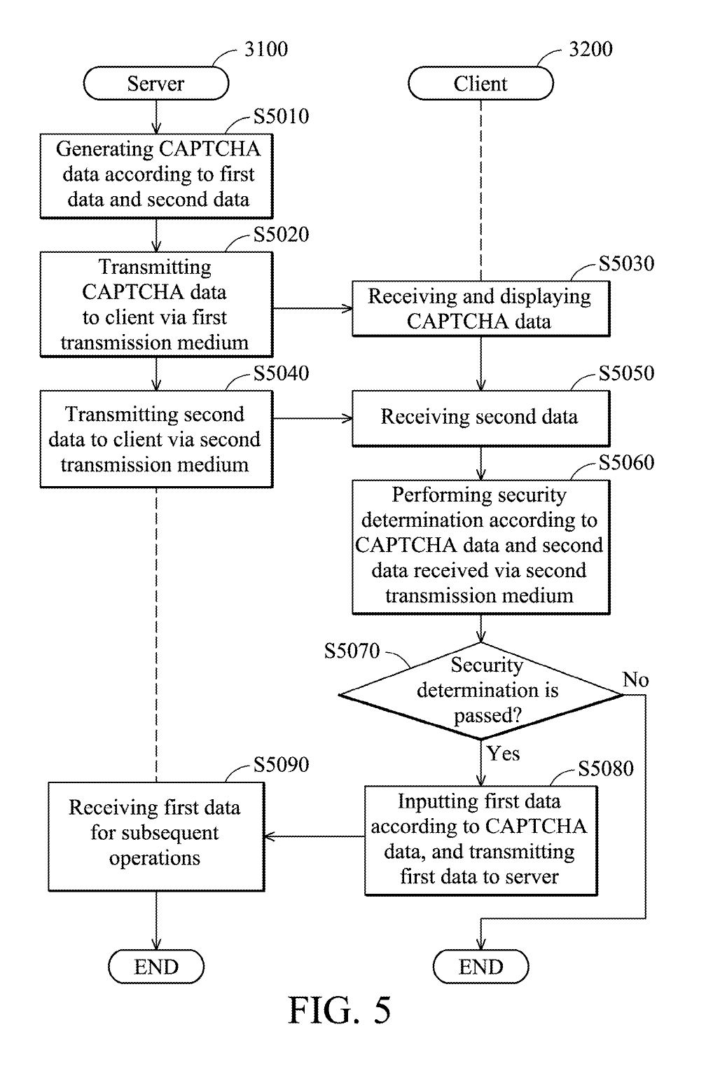

FIG. 5 is a flowchart of an embodiment of a CAPTCHA management method of the invention. The embodiment of FIG. 5 is discussed as follows by referring to FIGS. 3 and 5.

In step S5010, the server 3100 generates the CAPTCHA data according to the first data 3110 and the second data 3120. It is noted that, the first data 3110 and the second data 3120 can be known by viewing the CAPTCHA data. It is understood that, in some embodiments, the CAPTCHA data may be a figure, a video, or an audio. In step S5020, the server 3100 transmits the CAPTCHA data to the client 3200 via the first transmission medium 3310, and in step S5030, the client 3200 displays the CAPTCHA data received from the server 3100. In step S5040, the server 3100 transmits the second data 3120 used to generate the CAPTCHA data to the client 3200 via the second transmission medium 3320, and in step S5050, the client 3200 receives the second data 3120 used to generate the CAPTCHA data from the server 3100 via the second transmission medium 3320. Similarly, in some embodiments, the first transmission medium 3310 may be the Internet, and the second transmission medium 3320 may be an IP connection, or a telecommunication network. In some embodiments, the second data 3120 can be transmitted to the client 3200 via the second transmission medium 3320 using an email message or a message. After the client 3200 receives the second data 3120, in step S5060, the client 3200 performs a security determination according to the CAPTCHA data received via the first transmission medium 3310 from the server 3100 and the second data 3120 received via the second transmission medium 3320 from the server 3100. It is noted that, the client 3200 can know the second data in the CAPTCHA data by viewing the CAPTCHA data or using an automatic recognition mechanism. In some embodiments, the security determination is used to determine whether the second data in the CAPTCHA data and the second data 3120 received via the second transmission medium 3320 from the server 3100 are the same. When the second data in the CAPTCHA data and the second data 3120 received via the second transmission medium 3320 from the server 3100 are the same, the security determination is passed. When the security determination is not passed (No in step S5070), the procedure is terminated. When the security determination is passed (Yes in step S5070), in step S5080, the client 3200 inputs the first data according to the CAPTCHA data, and transmits the first data to the server 3100. Similarly, the client 3200 can know the first data in the CAPTCHA data by viewing the CAPTCHA data or using an automatic recognition mechanism. After the server 3100 receives the first data, in step S5090, subsequent operations are performed based on the received first data. For example, the server 3100 can determine whether the first data received from the client 3200 and the first data 3110 originally used to generate the CAPTCHA data are the same.

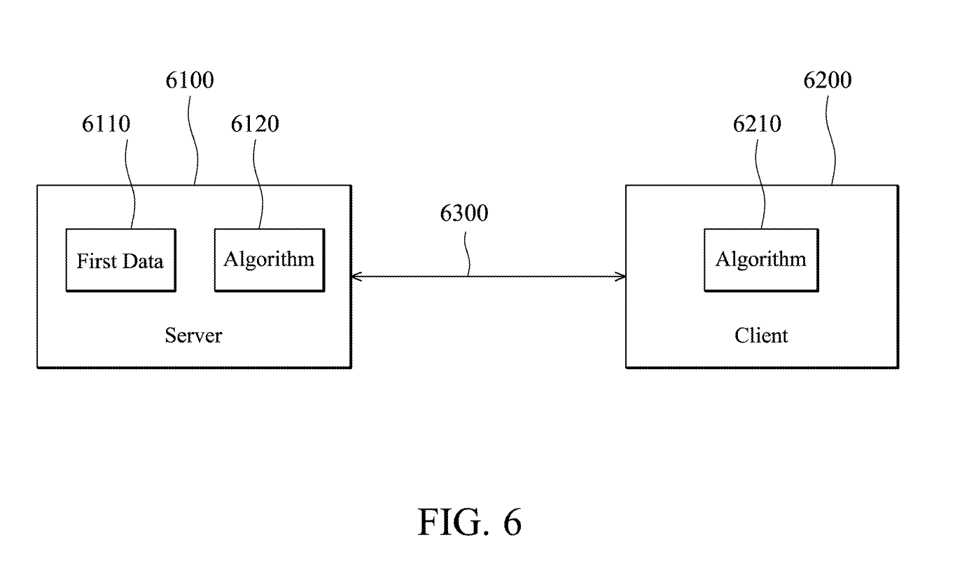

FIG. 6 is a schematic diagram illustrating another embodiment of a CAPTCHA management system of the invention.

The CAPTCHA system comprises a server 6100 and a client 6200. The server 6100 can have first data 6110 and an algorithm 6120. The algorithm 6120 can generate second data according to various conditions. For example, the algorithm 6120 can generate different second data according to different time points. In another example, the algorithm 6120 can generate different second data according to different input data. The first data 6110 and the second data generated by the algorithm 6120 can be used to generate CAPTCHA data. It is noted that, the first data 3110 and the second data can be known by viewing the CAPTCHA data. It is understood that, in some embodiments, the CAPTCHA data may be a figure, a video, or an audio. In this embodiment, the server 6100 can transmit the CAPTCHA data to the client 6200 via a transmission medium 6300. It is understood that, in some embodiments, the transmission medium 6300 may be the Internet, an IP connection, or a telecommunication network. The client 6200 has an algorithm 6210. It is noted that, in some embodiments, the algorithm 6120 in the server 6100 and the algorithm 6210 in the client 6200 may be the same. Similarly, the algorithm 6210 can generate second data according to various conditions. For example, the algorithm 6210 can generate different second data according to different time points. In another example, the algorithm 6210 can generate different second data according to different input data. It is understood that, in some embodiments, the algorithm 6210 in the client 6200 may be stored in a data carrier (not shown), wherein the data carrier has a display unit for displaying the generated second data. The CAPTCHA management method is discussed later.

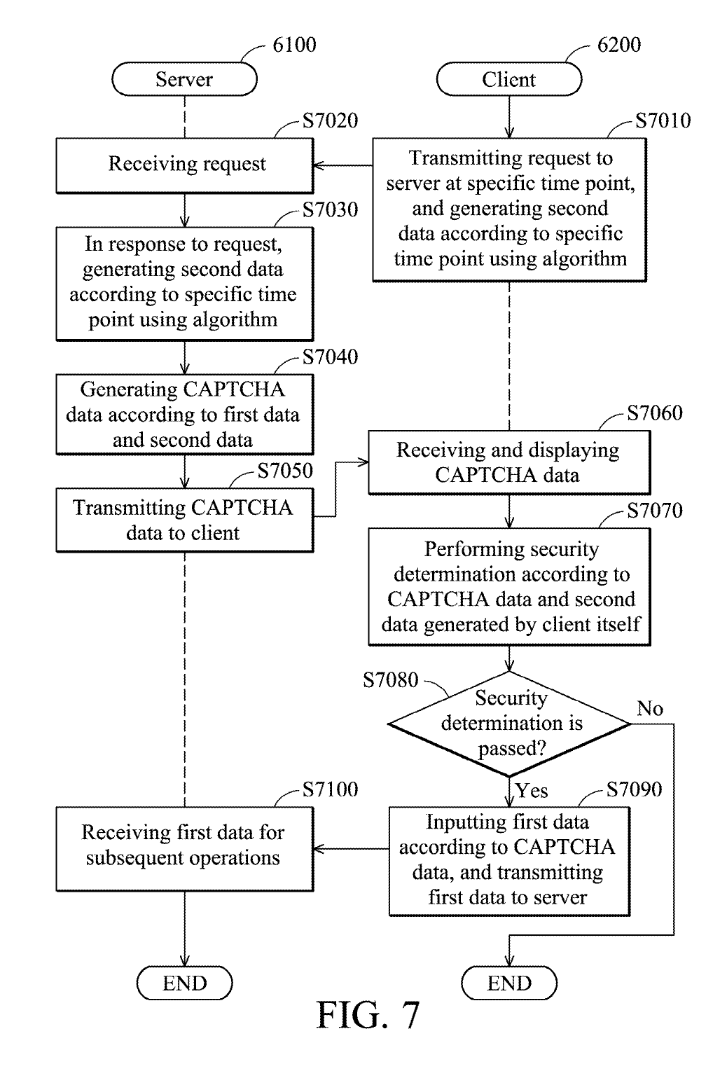

FIG. 7 is a flowchart of an embodiment of a CAPTCHA management method of the invention. The embodiment of FIG. 7 is discussed as follows by referring to FIGS. 6 and 7. It is noted that, in this embodiment, the second data can be varied based on respective time points. That is, the algorithm can generate different second data according to different time points.

In step S7010, the client 6200 transmits a request to the server 6100 via the transmission medium 6300 at a specific time point, and generates second data according to the specific time point using the algorithm 6210. In step S7020, the server 6100 receives the request, and in step S7030, in response to the request, the server 6100 generates second data according to the specific time point using the algorithm 6120. Then, in step S7040, the server 6100 generates the CAPTCHA data according to the first data 6110 and the second data. It is noted that, the first data 6110 and the second data can be known by viewing the CAPTCHA data. It is understood that, in some embodiments, the CAPTCHA data may be a figure, a video, or an audio. In step S7050, the server 6100 transmits the CAPTCHA data to the client 6200 via the transmission medium 6300. After the client 6200 receives the CAPTCHA data, in step S7060, the client 6200 displays the CAPTCHA data received from the server 6100. Then, in step S7070, the client 6200 performs a security determination according to the CAPTCHA data received via the transmission medium 6300 from the server 6100 and the second data generated by the client 6200. It is noted that, the client 6200 can know the second data in the CAPTCHA data by viewing the CAPTCHA data or using an automatic recognition mechanism. In some embodiments, the security determination is used to determine whether the second data in the CAPTCHA data and the second data generated by the client 6200 are the same. When the second data in the CAPTCHA data and the second data generated by the client 6200 are the same, the security determination is passed. When the security determination is not passed (No in step S7080), the procedure is terminated. When the security determination is passed (Yes in step S7080), in step S7090, the client 6200 inputs the first data according to the CAPTCHA data, and transmits the first data to the server 6100. Similarly, the client 6200 can know the first data in the CAPTCHA data by viewing the CAPTCHA data or using an automatic recognition mechanism. After the server 6100 receives the first data, in step S7100, subsequent operations are performed based on the received first data. For example, the server 6100 can determine whether the first data received from the client 6200 and the first data 6110 originally used to generate the CAPTCHA data are the same.

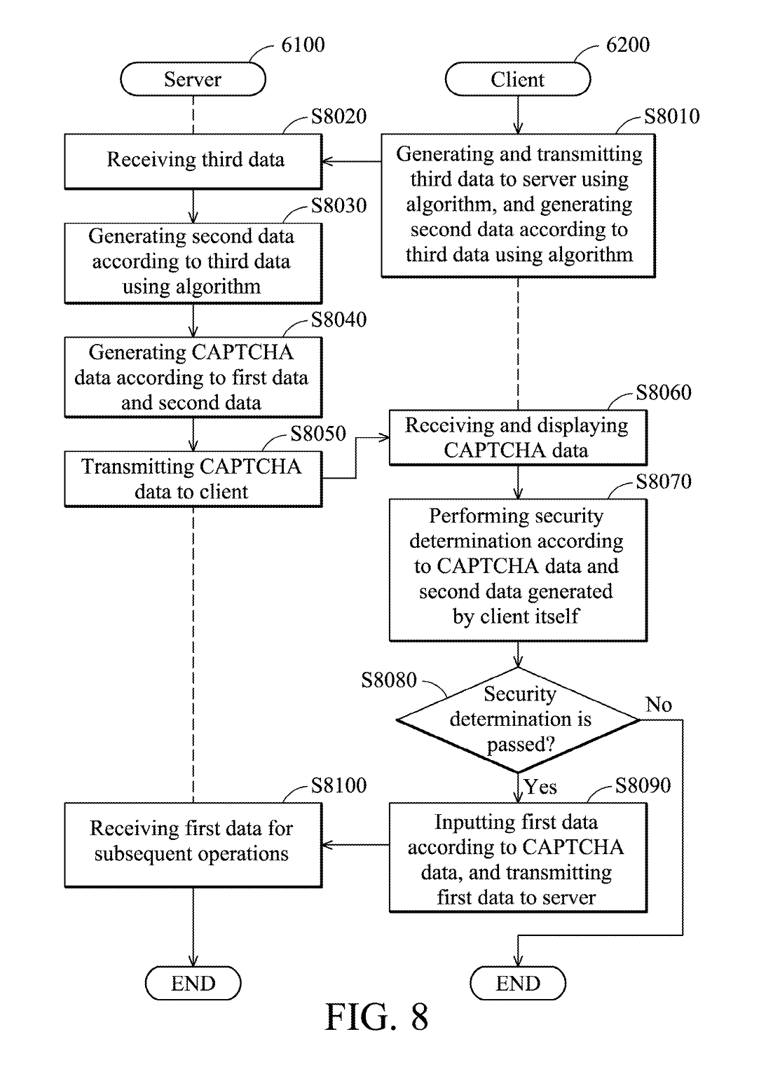

FIG. 8 is a flowchart of an embodiment of a CAPTCHA management method of the invention. The embodiment of FIG. 8 is discussed as follows by referring to FIGS. 6 and 8. It is noted that, in this embodiment, the algorithm can generate different second data according to different input data.

In step S8010, the client 6200 generates third data according to the algorithm 6210, and transmits the third data to the server 6100 via the transmission medium 6300. Additionally, the client 6200 generates second data according to the third data using the algorithm 6210. In step S8020, the server 6100 receives the third data, and in step S8030, the server 6100 generates second data according to the third data using the algorithm 6120. Then, in step S8040, the server 6100 generates the CAPTCHA data according to the first data 6110 and the second data. It is noted that, the first data 6110 and the second data can be known by viewing the CAPTCHA data. Similarly, in some embodiments, the CAPTCHA data may be a figure, a video, or an audio. In step S8050, the server 6100 transmits the CAPTCHA data to the client 6200 via the transmission medium 6300. After the client 6200 receives the CAPTCHA data, in step S8060, the client 6200 displays the CAPTCHA data received from the server 6100. Then, in step S8070, the client 6200 performs a security determination according to the CAPTCHA data received from the server 6100 and the second data generated by the client 6200. It is noted that, the client 6200 can know the second data in the CAPTCHA data by viewing the CAPTCHA data or using an automatic recognition mechanism. Similarly, in some embodiments, the security determination is used to determine whether the second data in the CAPTCHA data and the second data generated by the client 6200 are the same. When the second data in the CAPTCHA data and the second data generated by the client 6200 are the same, the security determination is passed. When the security determination is not passed (No in step S8080), the procedure is terminated. When the security determination is passed (Yes in step S8080), in step S8090, the client 6200 inputs the first data according to the CAPTCHA data, and transmits the first data to the server 6100. Similarly, the client 6200 can know the first data in the CAPTCHA data by viewing the CAPTCHA data or using an automatic recognition mechanism. After the server 6100 receives the first data, in step S8100, subsequent operations are performed based on the received first data. For example, the server 6100 can determine whether the first data received from the client 6200 and the first data 6110 originally used to generate the CAPTCHA data are the same.

As described, the server and the client can generate the information which is trusted by the server and the client by using any manner. For example, the server can provide several figures to the client via a specific transmission medium, and the client can select one of the figures, such that the server knows the selection of the client, thus generating the information which is trusted by the server and the client. In another example, the client can upload a figure to the server via a specific transmission medium, such that the server knows the selected figure of the client, thus generating the information which is trusted by the server and the client. It is noted that again, the server and the client can generate the information which is trusted by the server and the client by using any manner.

Therefore, the CAPTCHA management methods and systems can perform additional managements, such as a security determination for CAPTCHA data, thus improving the effectiveness of CAPTCHA. The client can determine whether the CAPTCHA data transmitted from the server has the information which is trusted by the server and the client, thus to recognize that the CAPTCHA data is transmitted from a trusted server, but not from animus websites or hackers, thereby preventing malicious computer attacks, such as phishing.

CAPTCHA management methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed:

1. A CAPTCHA (Completely Automated Public Test to tell Computers and Humans Apart) management method, comprising:
generating CAPTCHA data according to first data and second data by a server, wherein the first data and the second data are known by viewing the CAPTCHA data;
transmitting the CAPTCHA data to a client by the server via a first transmission medium; and
transmitting the second data to the client by the server via a second transmission medium,
wherein the client inputs the first data for processing according to the CAPTCHA data.

2. The method of claim 1, further comprising:
performing a security determination according to the CAPTCHA data received via the first transmission medium and the second data received via the second transmission medium by the client; and
when the security determination is passed, inputting the first data for processing.

3. The method of claim 1, wherein the CAPTCHA data comprises a figure, a video, or an audio.

4. The method of claim 1, wherein the first transmission medium comprises the Internet, and the second transmission medium comprises an IP (Internet Protocol) connection, or a telecommunication network.

5. The method of claim 4, wherein the second data is transmitted to the client via the second transmission medium using an email message or a message.

6. A CAPTCHA (Completely Automated Public Test to tell Computers and Humans Apart) management method, comprising:
providing first data in a server;
generating second data according to an algorithm by the server;
generating CAPTCHA data according to first data and second data by the server, wherein the first data and the second data are known by viewing the CAPTCHA data; and
transmitting the CAPTCHA data to a client by the server,
wherein the client has the algorithm, and generates the second data according to the algorithm, and inputs the first data for processing according to the CAPTCHA data.

7. The method of claim 6, wherein the second data is varied according to an algorithm with time, and when the client transmits a request corresponding to the CAPTCHA data to the server at a specific time point, in response to the request, the server generates the second data according to the specific time point using the algorithm.

8. The method of claim 6, further comprising:
generating third data according to the algorithm by the client, and generating the second data according to the third data using the algorithm by the client;
transmitting the third data to the server by the client; and
generating the second data according to the third data by the server using the algorithm.

9. The method of claim 6, wherein the algorithm in the client is stored in a data carrier, and the data carrier has a display unit for displaying the second data.

10. The method of claim 6, further comprising:
performing a security determination according to the CAPTCHA data received from the server and the second data generated by the client itself by the client; and
when the security determination is passed, inputting the first data for processing.

11. The method of claim 6, wherein the CAPTCHA data comprises a figure, a video, or an audio.

12. A CAPTCHA (Completely Automated Public Test to tell Computers and Humans Apart) management system, comprising:
a server generating CAPTCHA data according to first data and second data, wherein the first data and the second data are known by viewing the CAPTCHA data, transmitting the CAPTCHA data to a client via a first transmission medium, and transmitting the second data to the client via a second transmission medium,
wherein the client inputs the first data for processing according to the CAPTCHA data.

13. The system of claim 12, wherein the client further performs a security determination according to the CAPTCHA data received via the first transmission medium and the second data received via the second transmission medium, and when the security determination is passed, the client inputs the first data for processing.

14. The system of claim 12, wherein the CAPTCHA data comprises a figure, a video, or an audio.

15. The system of claim 12, wherein the first transmission medium comprises the Internet, and the second transmission medium comprises an IP (Internet Protocol) connection, or a telecommunication network.

16. The system of claim 15, wherein the second data is transmitted to the client via the second transmission medium using an email message or a message.

17. A CAPTCHA (Completely Automated Public Test to tell Computers and Humans Apart) management system, comprising:
a server having first data and an algorithm, generating second data according to the algorithm, generating CAPTCHA data according to first data and second data, wherein the first data and the second data are known by viewing the CAPTCHA data, and transmitting the CAPTCHA data to a client,
wherein the client has the algorithm, and generates the second data according to the algorithm, and inputs the first data for processing according to the CAPTCHA data.

18. The system of claim 17, wherein the second data is varied according to an algorithm with time, and when the client transmits a request corresponding to the CAPTCHA data to the server at a specific time point, in response to the request, the server generates the second data according to the specific time point using the algorithm.

19. The system of claim 17, wherein the client further generates third data according to the algorithm, generates the second data according to the third data using the algorithm, and transmits the third data to the server, wherein and the server generates the second data according to the third data using the algorithm.

20. The system of claim 17, wherein the algorithm in the client is stored in a data carrier, and the data carrier has a display unit for displaying the second data.

21. The system of claim 17, wherein the client further performs a security determination according to the CAPTCHA data received from the server and the second data generated by the client itself, and when the security determination is passed, the client inputs the first data for processing.

22. The system of claim 17, wherein the CAPTCHA data comprises a figure, a video, or an audio.

23. A CAPTCHA (Completely Automated Public Test to tell Computers and Humans Apart) management method, comprising:
determining information which is trusted by a server and a client;
generating CAPTCHA data, and combining the information which is trusted by the server and the client with the CAPTCHA data by the server, wherein the information which is trusted by the server and the client is known by viewing the CAPTCHA data;
transmitting the CAPTCHA data to the client by the server; and
determining whether to perform subsequent operations based on the CAPTCHA data by the client according to the information which is trusted by the server and the client, which is combined with the CAPTCHA data.

24. A machine-readable storage medium comprising a computer program, which, when executed, causes a device to perform a CAPTCHA (Completely Automated Public Test to tell Computers and Humans Apart) management method, wherein the method comprises:
generating CAPTCHA data according to first data and second data, wherein the first data and the second data are known by viewing the CAPTCHA data;
transmitting the CAPTCHA data to a client via a first transmission medium; and
transmitting the second data to the client via a second transmission medium,
wherein the client inputs the first data for processing according to the CAPTCHA data.

25. A machine-readable storage medium comprising a computer program, which, when executed, causes a device to perform a CAPTCHA (Completely Automated Public Test to tell Computers and Humans Apart) management method, wherein the method comprises:
generating second data according to an algorithm;
generating CAPTCHA data according to first data and the second data, wherein the first data and the second data are known by viewing the CAPTCHA data; and
transmitting the CAPTCHA data to a client,
wherein the client has the algorithm, and generates the second data according to the algorithm, and inputs the first data for processing according to the CAPTCHA data.
